(19) United States
(12) Patent Application Publication
(10) Pub. No.: US 2013/0183879 A1
(43) Pub. Date: Jul. 18, 2013

(54) ALLERGEN DEACTIVATOR COMPOSITION, ARTICLES AND METHODS

(71) Applicants: Junseok Lee, Uiwang-si (KR); Seonok Lee, Yongin-si (KR)

(72) Inventors: Junseok Lee, Uiwang-si (KR); Seonok Lee, Yongin-si (KR)

(73) Assignee: 3M INNOVATIVE PROPERTIES COMPANY, St. Paul, MN (US)

(21) Appl. No.: 13/825,626

(22) PCT Filed: Oct. 4, 2011
(86) PCT No.: PCT/US2011/054708

§ 371 Date: Mar. 22, 2013

(30) Foreign Application Priority Data
Oct. 5, 2010 (KR) 10-2010-0097050

(51) Int. Cl. C11D 1/24; B01D 39/00; D06M 13/272

(52) U.S. Cl. CPC C11D 1/24; D06M 13/272; B01D 39/00
USPC 442/123; 96/226; 562/75; 252/88.2; 510/109; 427/372.2; 427/244

(57) ABSTRACT

An allergen deactivator including a compound of the following Formula 1: wherein R represents a straight or branched chain alkyl group of C₁ to C₃₀, and X represents H, Na, K, Mg or Ca. Also disclosed is a spray, a filter, a fiber, a fabric, a nonwoven article, a substrate, and a detergent using the allergen deactivator including the compound of Formula 1.

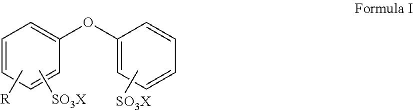

### TECHNICAL FIELD

The present disclosure relates to a composition, articles and methods useful in at least partially deactivating an allergen, and more particularly to an allergen deactivator composition capable of deactivating allergens derived from dust mites, pollens and pets that may cause indoor or outdoor allergies.

### BACKGROUND

According to statistics, approximately 20% of American people suffer from allergies. An allergy is a reaction of an organism's immune-defense system against a foreign substance (containing e.g. an antigen) to which the organism is exposed, that is, a generally undesirable response of an organism's immune system to an antigen produced by exposure to the foreign substance. Generally, when the foreign substance containing the antigen is first presented to the organism, the organism produces an antibody and lymphocytes specific to the antigen, and then, when the same foreign substance is later presented to the organism again, the organism generates various immune responses to the antigen as a defense system for self-protection, which immune response to the antigen produces an allergic reaction. Symptoms of an allergic reaction can range from non life threatening (e.g. watery eyes, sneezing and itching) to potentially life threatening (e.g. breathing difficulties or anaphylactic shock) or even death.

An allergen is any substance that can cause an allergic reaction and includes house dust mites, pollens, animal fur, skin debris, drugs, vegetable fibers, bacteria, foods, hair dying agents, chemicals and so on. Among these common allergens, dust mites are believed to trigger an allergic reaction when their excrement is exposed to the human body through breathing or direct skin contact. Fur and skin debris of animals (e.g. pets) may also act as allergens. However, pollens are believed to be the most common allergens. When pollens in the air are exposed to the body through the eyes, nose, lungs, or skin, an allergic reaction can be triggered. In particular, the inhalation of pollens through the nose or mouth can trigger a type of seasonal allergic rhinitis called a pollen allergy.

Development of allergies in animals or humans may take 2 years or more from the time of initial exposure to the allergen, and the manifested symptoms and duration of an allergy attack may become progressively worse on each exposure to the allergen. In some cases, allergic symptoms have been known to manifest themselves for a period of six months or even longer after initial exposure to the allergen, for example, an animal-derived allergen.

In some cases, it may be possible to decompose or remove an allergen from an air stream. For example, PCT Pub. Pat. App. WO 2005/047414 discloses an allergen decomposer comprising metal phthalocyanine derivatives as an active ingredient, and the allergen decomposition properties thereof. Similarly, WO 2006/011541 discloses an air filter comprising a natural ingredient extracted from Gingko leaves. However, such air filters may be easily destroyed by heat or light in outdoor use. Generally, it is difficult to remove allergens in the air by using a common air or dust filters.

Recently, an air filter claiming anti-allergic properties has been developed by Mitsubushi Motors Corp. The manufacturer claims that such a filter, using enzymes and urea, can effectively attenuate and deactivate allergens such as dust mites, pollens and the like. Nissan Motors Corp. has also recently announced a filter using the claimed anti-allergic effects of naturally occurring polyphenols found in grape seeds. Additionally, Toyota Motors Corp. has recently developed a car seat fabric claimed to be useful for the removal of dust mites, and that manufacturer reported that the new fabric seat comprises an allergen deactivator which protects against more than about 98% of dust mite allergens present at the surface of the car seat.

### SUMMARY

The art continually searches for improved compositions and methods for removing or decomposing allergens in air. Thus, in one aspect, the present disclosure describes an allergen deactivator having an excellent property of denaturing or decomposing allergens. As a result of studying benzene sulfonic acid or salts thereof traditionally used as an active ingredient of a detergent, the present inventors have found that these compounds surprisingly can be used as active ingredients in an allergen deactivator with excellent allergen degradation properties.

In some exemplary embodiments, the allergen deactivator of the present disclosure provides good anti-allergic (e.g. allergen-deactivating or allergen decomposing) effects. Thus, in another aspect, the allergen deactivator according to any of the foregoing embodiments can be incorporated into a liquid material, preferably a liquid material that may be sprayed onto or otherwise applied to various kinds of substrates, including, for example, a filler, a fiber, a fabric, a nonwoven article, a seat, a detergent, a filter, and the like. In some exemplary embodiments, the substrate is a filter. In certain exemplary embodiments, the filter is an HVAC filter, a vehicle cabin air filter, or a personal air filter (e.g. a respirator).

In another aspect, the disclosure describes a method of using the allergen according to any of the foregoing embodiments, the method including providing the allergen activator in liquid form, and applying the allergen activator to a surface of a substrate. In certain exemplary embodiments, the method further includes removing at least a portion of the allergen activator from the surface of the substrate. In certain exemplary embodiments, drying the substrate to remove at least a portion of the allergen activator from the surface of the substrate involves heating the substrate.

Various aspects and advantages of exemplary embodiments of the present disclosure have been summarized. The above Summary is not intended to describe each illustrated embodiment or every implementation of the present invention. Further features and advantages are disclosed in the embodiments that follow. The Detailed Description which follows more particularly exemplifies certain preferred embodiments using the principles disclosed herein.

### DETAILED DESCRIPTION

In the present disclosure, the compound of the following Formula 1 is an active ingredient for achieving anti-allergic effects:

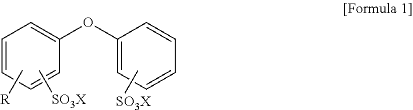

wherein R is a C₁-C₃₀ linear or branched chain alkyl group, and X is H, Na, K, Mg or Ca.

In Formula 1, R has 1 to 30 carbon atoms, preferably 10 to 25 carbon atoms. In addition, R is a linear or branched chain alkyl group, preferably a linear chain alkyl group.

The compound of Formula 1 is one kind of anionic surfactant showing excellent detergency and emulsifying property and has an extremely low critical micelle concentration (CMC). While not wishing to be bound by any particular theory, it is presently believed that the compound of Formula 1 may deactivate allergens by absorbing or adsorbing a protein substance which triggers an allergic response, and denaturing the same.

In exemplary allergen deactivator embodiments of the present disclosure, the content of the compound of Formula 1 in the allergen deactivator material is not particularly limited, but preferably, the allergen deactivator of the present disclosure contains the compound of Formula 1 in an amount of 0.5 to 50 wt %, more preferably in an amount of 5 to 20 wt %, based on the weight of the allergen deactivator composition.

In some exemplary embodiments, it may be preferable to maintain the content of the compound of Formula 1 above 0.5 wt %, for example, above 5 wt %, 10 wt %, 15 wt %, 20 wt %, or even 25 wt % or more, in order to maintain a high effective amount of allergen deactivator over an extended time period. In other exemplary embodiments, it may be preferable to maintain the content of the compound of Formula 1 below 50 wt %, for example, below 45 wt %, 40 wt %, 35 wt %, 30 wt %, or even 25 wt % or less, in order to reduce the viscosity or suppress bubble formation of the allergen deactivator.

In some exemplary embodiments of the present disclosure, an organic acid serves as an adjuvant to enhance anti-allergy effects. While not wishing to be bound by any particular theory, it is presently believed that the organic acid of the present disclosure helps to lower pH, thereby helping to promote allergen deactivation by the compound of Formula 1. In other words, it is presently believed that the organic acid facilitates denaturing of dust mite allergens susceptible to the action of the compound of Formula 1 under acidic pH conditions.

Suitable organic acids are one or more organic acids selected from citric acid, malic acid, stannic acid, benzoic acid, lactic acid, glycolic acid, ascorbic acid, gallic acid, aluconic acids, benzoic acid and maleic acid. In some exemplary embodiments, it is preferable to use citric acid as an adjuvant.

The content of the organic acid in the allergen deactivator of the present disclosure is not limited, but it is preferable to contain the organic acid in an amount of 0.5 to 50 wt %, more preferably 5 to 20 wt %, based on the weight of the allergen deactivator composition. In some exemplary embodiments, it may be preferable to maintain the content of the organic acid above 0.5 wt %, for example, above 5 wt %, 10 wt %, 15 wt %, 20 wt %, or even 25 wt % or more, in order to maintain the pH at a sufficiently low level, for example, at pH 6.9 or less, 6 or less, 5 or less, 4 or less, 3 or less, or even lower. In other exemplary embodiments, it may be preferable to maintain the content of the organic acid below 50 wt %, for example, below 45 wt %, 40 wt %, 35 wt %, 30 wt %, or even 25 wt % or less, so that the pH is not excessively lowered so as to cause skin irritation, for example, at pH of 3 or more, 4 or more, 5 or more or even 6 or more, up to pH 6.9.

Another adjuvant, the tetrasodium salt of ethylenediaminetetraacetic acid (EDTA), tetrasodium-EDTA, has been used as a chelating agent in the present disclosure in order to enhance the allergen deactivation effects of the compound of Formula 1 as described in the present disclosure. The content of tetrasodium EDTA in the allergen deactivator of the present disclosure is not particularly limited, but it is preferable to include tetrasodium-EDTA in an amount of 0.2 to 2 wt %, more preferably 0.5 to 1 wt %, based on the weight of the allergen deactivator composition.

When the content of tetrasodium-EDTA is 0.2 wt % or more, it is favorable in blocking effects as a chelating agent. In some exemplary embodiments, it may be preferable to maintain the content of the tetrasodium-EDTA in the allergen deactivator composition above 0.2 wt %, for example, above 0.5 wt %, 1.0 wt %, 2.0 wt %, 2.5 wt %, or even 3 wt % or more of the allergen deactivator composition, in order to maintain an effective amount of tetrasodium-EDTA in the allergen deactivator composition. In other exemplary embodiments, it may be preferable to maintain the content of the organic acid below 10 wt %, for example, below 9 wt %, 8 wt %, 7 wt %, 6 wt %, or even 5 wt % or less, in order to avoid problems of decreasing water solubility of the tetrasodium-EDTA in the acid-pH range, thereby restricting the content of tetrasodium-EDTA which could be included when mixed with an organic acid.

In some exemplary embodiments of the present disclosure, one or more C₁-C₆ alcohols may be used as adjuvants to help obtain rapid drying the allergen deactivator when the allergen deactivator is used in the form of a coating or spray to treat a substrate, for example, a filter surface or a nonwoven fabric, with the allergen deactivator composition. In certain exemplary embodiments, ethanol is preferred as a C₁-C₆ alcohol, due to safety considerations.

The content of C₁-C₆ alcohols in the allergen deactivator of the present disclosure is not particularly limited, but it is preferable to include one or more C₁-C₆ alcohols in an amount of 1 to 20 wt %, more preferably 4 to 10 wt %, based on the weight of the allergen deactivator composition.

In some exemplary embodiments, it may be preferable to maintain the content of the C₁-C₆ alcohols in the allergen deactivator composition above 1 wt %, for example, above 5 wt %, 10 wt %, 15 wt %, or even 20 wt % or more of the allergen deactivator composition, in order to maintain an effective rapid drying rate for the allergen deactivator composition. In other exemplary embodiments, it may be preferable to maintain the content of the C₁-C₆ alcohols below 20 wt %, for example, below 15 wt %, 10 wt %, 7.5 wt %, or even 5 wt % or less, in order to avoid any combustibility or flammability issues for the allergen deactivator composition.

In the present disclosure, water is typically used as a solvent. The content of water in the allergen deactivator of the present disclosure is not limited, but it is typical to use as much water as required to achieve 100% of the allergen deactivator composition after specifying the amount of the active ingredients (e.g. the compound of formula 1 and any added adjuvants) in the allergen deactivator composition. However, it is understood that other water soluble or water miscible ingredients (e.g. water soluble or water miscible organic and/or inorganic compounds) may be included in the allergen deactivator composition.

The allergen deactivator composition according to the present disclosure can be used in or on a filler, a fabric, a nonwoven material, a fiber and the like. In some exemplary embodiments, the allergen deactivator composition may be used in the form of a spray, so that the allergen deactivator may be applied to virtually any surface, for example, a heating, ventilation and air conditioning (HVAC) filter (e.g. an air filter or furnace filter surface), a vehicle cabin air filter (e.g. an air filter for filtering air entering the passenger cabin of a transportation vehicle such as an automobile, aircraft, ship, submarine, or the like), or a personal air filter (e.g. a respirator), to impart anti-allergic effects to that surface by promoting the deactivation, denaturing, or decomposition of at least some allergens.

Exemplary embodiments of the present disclosure have been described above and are further illustrated below by way of the following Examples, which are not to be construed in any way as imposing limitations upon the scope of the present invention. On the contrary, it is to be clearly understood that resort may be had to various other embodiments, modifications, and equivalents thereof which, after reading the description herein, may suggest themselves to those skilled in the art without departing from the spirit of the present disclosure and/or the scope of the appended claims.

### EXAMPLES

Preparation of samples and reactive agents and methods for measuring test results used in the following Examples of the present disclosure are as follows. The present disclosure used an ELISA (enzyme-linked immunosorbent assay) test as a method for measuring deactivation capabilities of various allergen deactivator composition with respect to specific allergens. This method can measure an allergen concentration by monitoring a change in color due to an antigen-antibody reaction. Here, in each Example and Comparative Example, the tests were performed using different kinds of specific active ingredients and allergens, and different coating amounts thereof

### 1. Sample Preparation

An allergen deactivator comprising 10 wt % of the compound of Formula 1 as an active ingredient, 4.5 wt % of citric acid anhydride, 0.5 wt % of EDTA salt, 5 wt % of ethanol and 80 wt % of water was prepared. Spunbond (weight: 80 g/sqm) was used as a filter. The allergen deactivator was coated on the filter through doping and drying processes, to thereby obtain a sample for testing. The sample used in the test was 5 mm×5 mm in size.

### 2. Preparation of Allergens

Allergens used in the ELIZA tests were:

1) House dust mite residue: Der p 1, Der f 1, Der p 2, and Der f 2

2) Pollen: Bet v 1 (i.e. birch tree pollen)

3) Pet residue: Can f 1 (i.e. pet dander)

An ELISA test kit (Inbio GmbH, Jülich, Germany) for each antigen was used, and each antigen was dissolved in PBS to thereby prepare 250 ng/ml of a test allergen solution. Other reagents were prepared according to the ELISA kit manufacturer's indication.

3. Testing of Each Antigen with Sample Having Applied Allergen Deactivator

Each sample was cut into 5 mm×5 mm in size and then soaked in 300 ul of the allergen solution (250 ng/ml) at 25° C. for 1 hour. After one hour of soaking, 100 ul of the solution (supernatant) was poured into a 96-well microplate coated with an antibody. Absorbance of the microplate was measured at 405 nm by using a microplate reader, and then, the concentration of an allergen in each sample was measured.

### 4. Measurement of Test Results

In order to calculate allergen deactivation efficacy, the concentration of each antigen in the reaction solution with a sample was measured by using a microplate reader at 405 nm.

Efficiency (%)=(250-allergen concentration measured for each sample)/250

### Examples 1-6 and Comparative Examples 1-5

### Testing Different Kinds of Surfactants as Active Ingredients

Removal efficiency of Der p 1 was measured by using samples comprising different compounds of Formula 1 as an active ingredient of an allergen deactivator (Examples 1-6), a sample having no surfactant (Comparative Example 1), and samples comprising other surfactants instead of the compound of Formula 1 (Comparative Examples 2-5). Here, the coating amount of an active ingredient in the sample was 1 g/m².

The results are as shown in Table 1:

TABLE 1

| | | Removal |
|---|---|---|
| | | Efficiency of |
| Example | Active Ingredient | Der p 1 (%) |
| Example 1 | Compound of Formula 1 wherein R is | 76 |
| | linear chain C6 alkyl | |
| Example 2 | Compound of Formula 1 wherein R is | 80 |
| | linear chain C10 alkyl | |
| Example 3 | Compound of Formula 1 wherein R is | 87 |
| | linear chain C12 alkyl | |
| Example 4 | Compound of Formula 1 wherein R is | 84 |
| | branched chain C12 alkyl | |
| Example 5 | Compound of Formula 1 wherein R is | 91 |
| | linear chain C16 alkyl | |
| Example 6 | Compound of Formula 1 wherein R is | 90 |
| | branched chain C22 alkyl | |
| Comparative | No treatment | 12 |
| Example 1 | | |
| Comparative | Sodium dodecyl benzene sulfate | 65 |
| Example 2 | | |
| Comparative | Dioctyl sodium sulfosuccinate | 36 |
| Example 3 | | |
| Comparative | Sodium lauryl sulfate | 34 |
| Example 4 | | |
| Comparative | Sodium lauroyl sarcosinate | 34 |
| Example 5 | | |

### Examples 7-10

### Testing Different Kinds of Organic Acids and EDTA Salts

Allergen deactivation effects were measured by using Der f 1 as a test allergen and allergen deactivators comprising the following ingredients. The results are shown in Table 2.

TABLE 2

| | Disodium | | | | | | |
|---|---|---|---|---|---|---|---|
| | Hexadecyl | | | | | | Removal |
| | diphenyl oxide | Citric | Maleic | | | | Efficiency of |
| Example | disulfonate | Acid | Acid | EDTA | Ethanol | Water | der p 1 (%) |
| Example 7 | 10 | | | | 5 | 85 | 82 |
| Example 8 | 10 | 5 | | | 5 | 80 | 87 |
| Example 9 | 10 | | 5 | | 5 | 80 | 88 |
| Example 10 | 10 | | 4.5 | 0.5 | 5 | 80 | 91 |
| Example 5 | 10 | 4.5 | | 0.5 | 5 | 80 | 91 |

### Examples 11-16 and Comparative Example 6

### Testing of House Dust Mite Residue

Removal efficiencies were measured by using four kinds of house dust mites (Der p 1, Der f 1, Der p 2 and Der f 2) and allergen deactivators comprising disodium hexadecyl diphenyl oxide disulfonate as an active ingredient, wherein the tests were performed with varying the coating amount of the total active ingredient in the sample i.e., 0.5, 1, 2, 3, 4 and 8 g/m². The results are shown in Table 3.

TABLE 3

| | Coated | Removal | Removal | Removal | Removal |
|---|---|---|---|---|---|
| | Amount of | Efficiency | Efficiency | Efficiency | Efficiency |
| | Active | of Der | of Der | of Der | of Der |
| Example | Ingredient | p 1 (%) | p 2 (%) | f 1 (%) | f 2 (%) |
| Example 11 | 0.5 g/m² | 82 | 85 | 72 | 89 |
| Example 12 | 1 g/m² | 91 | 90 | 78 | 94 |
| Example 13 | 2 g/m² | 97 | 95 | 84 | 98 |
| Example 14 | 3 g/m² | 99 | 99 | 88 | 99 |
| Example 15 | 4 g/m² | 99 | 99 | 90 | 99 |
| Example 16 | 8 g/m² | 99 | 99 | 95 | 99 |
| Comparative | — | 12 | 10 | 9 | 14 |
| Example 6 | | | | | |

As a result of the tests, it has been found that the allergen deactivator of the present disclosure shows excellent allergen deactivation effects on Der p 1, Der f 1, Der p 2 and Der f 2 as compared with the untreated sample.

### Examples 17-22 and Compared Example 7

### Testing of Pollen and Pet Dander

Removal efficiencies were measured by using Bet v 1 and Can f 1 as a test allergen at a protein concentration of 250 ng/ml and allergen deactivators comprising disodium hexadecyl diphenyl oxide disulfonate as an active ingredient, wherein the tests were performed with varying the coating amount of the active ingredient in the sample, i.e., 0.5, 1, 2, 3, 4 and 8 g/m². The results are shown in Table 4.

TABLE 4

| | Coated Amount | Removal | Removal |
|---|---|---|---|
| | of Active | Efficiency of | Efficiency of |
| Example | Ingredient | Bet v 1 (%) | Can f 1 (%) |
| Example 17 | 0.5 g/m² | 84 | 81 |
| Example 18 | 1 g/m² | 90 | 88 |
| Example 19 | 2 g/m² | 95 | 92 |
| Example 20 | 3 g/m² | 98 | 96 |
| Example 21 | 4 g/m² | 99 | 97 |
| Example 22 | 8 g/m² | 99 | 99 |
| Comparative Example 7 | — | 12 | 11 |

As a result of the tests, it has been found that the allergen deactivator of the present disclosure shows excellent allergen deactivation effects on Bet v 1 and Can f 1 as compared with the untreated sample.

### Example 23 and Comparative Example 8

### Durability Test

A sample sheet was attached to a feefilter and was then installed on a RAP (air cleaner) unit. After the air cleaner was operated, a durability test was performed for 1 month by using a nonwoven sheet treated with 1 g/m² of an active ingredient (Example 23). Der p 1, Can f 1 and Bet v 1 were used as a test allergen. The same test was carried out to the untreated sample.

The test results are shown in Table 5.

TABLE 5

| | Removal | | Removal | | Removal | |
|---|---|---|---|---|---|---|
| | Efficiency of | | Efficiency of | | Efficiency of | |
| | Der p 1 (%) | | Bet v 1 (%) | | Can f 1 (%) | |
| | Before | After | Before | | Before | |
| Example | test | test | test | After test | test | After test |
| Example 23 | 91 | 87 | 90 | 89 | 88 | 85 |
| Comparative | 12 | 5 | 12 | 8 | 11 | 6 |
| Example 8 | | | | | | |

As a result of the tests, it has been found that the allergen deactivator of the present disclosure exhibits significantly high durability on Der p 1, Can f 1 and Bet v 1 as compared with the untreated sample.

While the specification has described in detail certain exemplary embodiments, it will be appreciated that those skilled in the art, upon attaining an understanding of the foregoing, may readily conceive of alterations to, variations of, and equivalents to these embodiments. Accordingly, it should be understood that this disclosure is not to be unduly limited to the illustrative embodiments set forth hereinabove.

Various exemplary embodiments have been described. These and other embodiments are within the scope of the following listing of disclosed embodiments.

1. An allergen deactivator comprising a compound of the following formula 1: 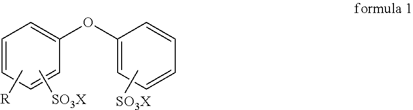
wherein R represents a straight or branched chain alkyl group of C₁ to C₃₀, and
X represents H, Na, K, Mg or Ca.

2. The allergen deactivator according to claim 1, further comprising at least one organic acid selected from the group consisting of citric acid, malic acid, tartaric acid, benzoic acid, lactic acid, glycolic acid, ascorbic acid, gallic acid, aluconic acid and maleic acid.

3. The allergen deactivator according to claim 2, wherein the organic acid is citric acid.

4. The allergen deactivator according to claim 1, further comprising the tetrasodium salt of ethylenediaminetetraacetic acid (tetrasodium-EDTA).

5. The allergen deactivator according to claim 1, further comprising:
the tetrasodium salt of ethylenediaminetetraacetic acid (tetrasodium-EDTA),
one or more C₁ to C₆ alcohols, and
water.

6. The allergen deactivator according to claim 1, wherein the compound of formula 1 is sodium hexadecyl diphenyloxide disulfonate.

7. The allergen deactivator according to claim 2, wherein the composition comprises:
0.5 to 50% by weight of the compound of formula 1,
0.5 to 50% by weight of the organic acid,
0.2 to 2% by weight of a tetrasodium salt of ethylenediaminetetraacetic acid (tetrasodium-EDTA),
1 to 20% by weight of one or more C₁ to C₆ alcohols, and
the balance of water, based on 100% by weight of the composition.

8. The allergen deactivator according to claim 7,
5 to 20% by weight of the compound of formula 1,
5 to 20% by weight of the organic acid,
0.5 to 1% by weight of the tetrasodium-EDTA,
4 to 10% by weight of the one or more C₁ to C₆ alcohols, and
the balance of water, based on 100% by weight of the composition.

9. A filter using the allergen deactivator according to claim 1.

10. A spray using the allergen deactivator according to claim 1.

11. A fabric using the allergen deactivator according to claim 1.

12. A nonwoven using the allergen deactivator according to claim 1.

13. A fiber using the allergen deactivator according to claim 1.

14. A detergent using the allergen deactivator according to claim 1.

15. A method of using the allergen deactivator according to claim 1, comprising:
providing the allergen activator in liquid form;
applying the allergen activator to a surface of a substrate.

16. The method of claim 15, further comprising:
drying the substrate to remove at least a portion of the allergen activator from the surface of the substrate.

17. The method of claim 16, wherein drying the substrate to remove at least a portion of the allergen activator from the surface of the substrate comprises heating the substrate.

18. The method of claim 15, wherein the substrate is selected from a filler, a fiber, a fabric, a nonwoven article, and a filter

19. The method of claim 18, wherein the substrate is a filter.

20. The method of claim 19, wherein the filter is an HVAC filter, a vehicle cabin air filter, or a personal air filter (respirator).
